(19) United States
(12) Patent Application Publication
(10) Pub. No.: US 2020/0014650 A1
(43) Pub. Date: Jan. 9, 2020

(54) METHOD FOR COLLECTING DATA RELATED TO DIALOG, COMPUTER-READABLE STORAGE MEDIUM, COMPUTER DEVICE AND SERVER SYSTEM

(71) Applicant: Line Corporation, Tokyo (JP)

(72) Inventor: Yu-Chuan WEI, Tokyo (JP)

(73) Assignee: Line Corporation, Tokyo (JP)

(21) Appl. No.: 16/453,079

(22) Filed: Jun. 26, 2019

(30) Foreign Application Priority Data
Jul. 5, 2018 (CN) 201810729179.2

(51) Int. Cl. H04L 12/58; H04L 12/18; H04N 1/44; G06F 17/22

(52) U.S. Cl. CPC H04L 51/16; G06F 17/2235; H04N 1/448; H04L 12/1813

(57) ABSTRACT

A method for collecting data related to dialog including receiving one or more user input conditions of a first user for a chat room including the first user and one or more second users associated with the first user, collecting data related to dialog from the chat room according to the user input conditions to generate a simplified dialog, and generating media data according to the simplified dialog may be provided. Further, a non-transitory computer-readable storage medium storing instructions for implementing the method, a computer device configured to perform the method, and a server system configured to perform the method may be provided.

### CROSS-REFERENCE TO RELATED APPLICATION

This non-provisional application claims priority under 35 U.S.C. § 119(a) on Patent Application No(s). 201810729179.2 filed in China on Jul. 5, 2018, the entire contents of which are hereby incorporated by reference.

### BACKGROUND

### 1. Field

The present disclosure relates to methods, products, devices and/or systems for collecting data related to dialog, and in particular to methods for collecting data related to dialog from a chat room according to user input conditions, computer-readable storage mediums, computer devices and/or a server systems.

### 2. Description of the Related Art

For users of the current real-time communication software, there is usually a problem that it is not easy to quickly obtain the specific media messages in the historical dialog record. Although the historical dialog record of a user can be completely stored in the user end or the server end of communication software, or simultaneously stored in the user end and the server end of communication software, it is usually time-consuming for certain users (especially the users have high frequency of use) to find meaningful or valuable media messages in the historical dialog record that has a large number of messages or has messages produced in a long time ago.

For example, user A feels like to find the indecent words that user B used to insult him in the historical dialog record in a group chat room in order to provide government agencies with the simplified dialog of text message including the indecent words in the historical dialog record in the form of snipped images as evidence, or post it on the social media to get attention of other people. However, because the historical dialog record has a large number of text messages, user A has to spend a lot of time to search the historical dialog record for finding the meaningful text messages (e.g. including the indecent words).

One example more. User A feels like to find the historical dialog record that he chatted with user C in memory of user C who passed away unfortunately. However, because the historical dialog record of user A chatting with user C includes text messages produced in a long time ago, user A has to spend a lot of time to search the historical dialog record for finding the commemorative text messages.

Further, after a user spends a lot of time to search out the specific text messages from the historical dialog record, the user further has to snip images from the specific paragraphs (i.e. the paragraphs including the specific text messages) of the historical dialog record one by one by himself, and then probably the user further has to rearrange a sequence of images, generate a downloading page or forwarding page of image, blur/mark images, store images or upload images by himself.

Because it is usually time-consuming to search media message in the current real-time communication software for obtaining the simplified dialog including the specific media message (e.g. taking the form of one or more snipped images), there is a desire to improve the current real-time communication software to bring users a more convenient and/or time-saving user experience.

### SUMMARY

Some objectives of the present disclosure are to provide methods for collecting data related to dialog, and in particular to methods for collecting data related to dialog from a chat room according to user input conditions based on at least one embodiment of the inventive concepts.

According an example embodiment of the present inventive concepts, a method includes receiving one or more user input conditions of a first user for a chat room including the first user and one or more second users associated with the first user, collecting data related to dialog from the chat room according to the user input conditions to generate a simplified dialog, and generating media data according to the simplified dialog.

In some example embodiments, the media data may include one of text data, audio and video data, image data, or audio data, and the user input conditions include at least one of specific user identifications in the chat room, at least one of specific time intervals, at least one of a number of messages prior or after the first user message in the chat room, or combinations thereof.

In some example embodiments, the method may further include generating a downloading page including a downloading link associated with the media data or a forwarding page including a forwarding link associated with the media data to allow the first user to download or forward the media data.

In some example embodiments, the method may further include blurring a part of the simplified dialog before the generating, wherein the generating may generate the media data according to the simplified dialog, which has been blurred in the blurring.

In some example embodiments, the blurred part of the simplified dialog may include at least one of specific user identifications, at least one of specific user messages, at least one of specific user image marks, or a combination thereof.

In some example embodiments, the method may further include receiving specific conditions for the blurring from the first user, and deciding the part of the simplified dialog to be blurred based on the specific conditions for the blurring.

In some example embodiments, the method may further include providing a user device of the first user with an input interface associated with the chat room that is configured to receive the user input conditions.

In some example embodiments, the generating may include at least one of compressing or encrypting the media data, and generating the downloading page or the forwarding page to allow the first user to download or forward the at least one of compressed or encrypted media data based on the downloading link or the forwarding link.

Based on at least one embodiment of the inventive concepts, the inventive concepts provide a non-transitory computer-readable storage medium which can collect data related to dialog from a chat room according to user input conditions of a first user by executing instructions stored thereon.

According to an example embodiment of the present inventive concepts, a non-transitory computer-readable storage medium storing instructions that, when executed by a computer, causes the computer to implement a method of collecting and providing dialog-related data. The method includes receiving one or more user input conditions of a first user for a chat room including the first user and one or more second users associated with the first user, collecting data related to dialog according to the user input conditions to generate a simplified dialog, and generating media data according to the simplified dialog.

In some example embodiments, the method may further include generating a downloading page including a downloading link associated with the media data or a forwarding page including a forwarding link associated with the media data to allow the first user to download or forward the media data.

In some example embodiments, the method may further include blurring a part of the simplified dialog.

Based on at least one embodiment of the inventive concepts, the inventive concepts provide a computer device which is configured to collect data related to dialog from a chat room according to user input conditions, and may be used in a user end.

According to an example embodiment of the present inventive concepts, a computer device includes a memory configured to store computer device-readable instructions and one or more processors configured to execute the computer device-readable instructions such that one or more processors are configured to receive one or more user input conditions of a first user for a chat room, collect data related to dialog according to the user input conditions to generate a simplified dialog, and generate media data according to the simplified dialog.

In some example embodiments, the one or more processors may be further configured to generate a downloading page including a downloading link associated with the media data or a forwarding page including a forwarding link associated with the media data to allow the first user to download or forward the media data.

In some example embodiments, the one or more processors may be further configured to blur a part of the simplified dialog.

Based on at least one embodiment of the inventive concepts, the inventive concepts provide a server system, which is configured to collect data related to dialog. The server system may collect the data related to dialog from a chat room according to user input conditions, and may be used in a server end.

According to an example embodiment of the present inventive concepts, a server system includes a memory configured to store computer device-readable instructions, and one or more processors configured to execute the computer device-readable instructions such that one or more processors are configured to receive user input conditions of a first user for a chat room, collect data related to dialog according to the user input conditions to generate a simplified dialog, and generate media data according to the simplified dialog.

In some example embodiments, the one or more processors may be further configured to generate a downloading page including a downloading link associated with the media data or a forwarding page including a forwarding link associated with the media data to allow the first user to download or forward the media data.

In some example embodiments, the one or more processors may be further configured to blur a part of the simplified dialog.

To achieve at least the above objectives, the present disclosure provides methods for collecting data related to dialog from a chat room according to the user input conditions, a non-transitory computer-readable storage medium, a computer device and a server system, as exemplified in any one of the above example embodiments.

Accordingly, the inventive concepts provide products, devices and systems that are capable of collecting the data related to dialog from the chat room according to the user input conditions. Therefore, the methods, products, devices and/or systems of the inventive concepts may bring users a more convenient and time-saving user experience.

### BRIEF DESCRIPTION OF THE DRAWINGS

FIG. 1 is a block diagram of a communication system according to an example embodiment of the present inventive concepts.

FIG. 2 is a flow chart of a method for collecting data related to dialog according to an example embodiment of the present inventive concepts.

FIG. 3 is a schematic diagram of a method for collecting data related to dialog of FIG. 2 realized in the communication system of FIG. 1.

FIG. 4 is a schematic diagram illustrating a method for collecting the data related to dialog from the displayed content of the monitor of the computer device according to an example embodiment of the present inventive concepts.

FIG. 5 is a flow chart of a method for collecting data related to dialog according to another example embodiment of the present inventive concepts.

FIG. 6 is a schematic diagram of a method for collecting data related to dialog of FIG. 5 realized in the communication system of FIG. 1.

FIG. 7 is a flow chart of a method for collecting data related to dialog according to still another example embodiment of the present inventive concepts.

FIG. 8 is a schematic diagram of a method for collecting data related to dialog of FIG. 7 realized in the communication system of FIG. 1.

FIG. 9 is a flow chart of a method for collecting data related to dialog according to yet another example embodiment of the present inventive concepts.

FIG. 10 is a schematic diagram of a method for collecting data related to dialog of FIG. 9 realized in the communication system of FIG. 1.

### DETAILED DESCRIPTION

To facilitate understanding of the objects, characteristics and/or effects of this present disclosure, some example embodiments are provided for the detailed description of the present disclosure together with the attached drawings.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list. In addition, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

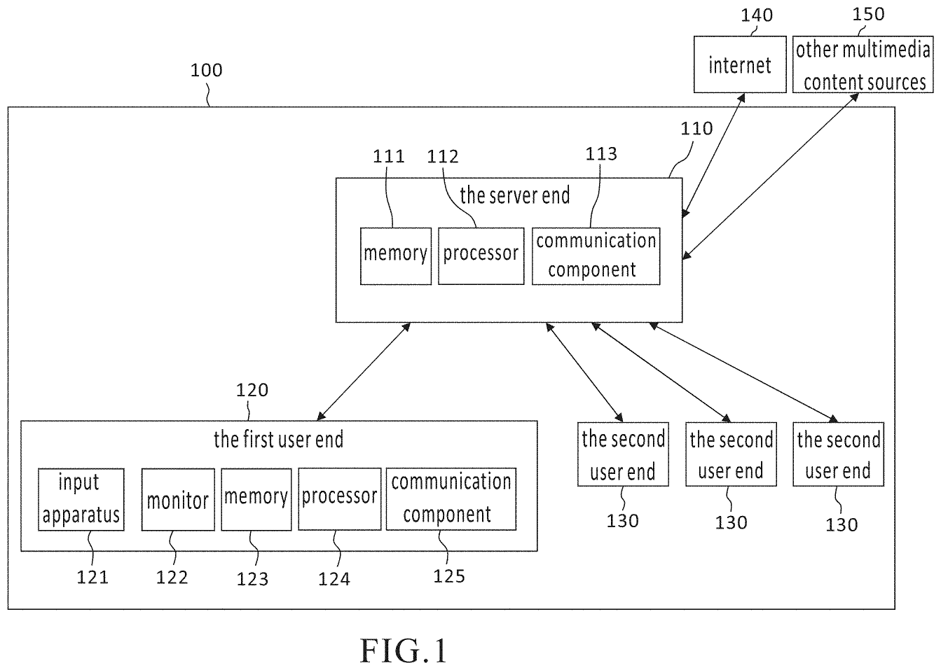

Referring to FIG. 1, FIG. 1 is a block diagram of a communication system according to an example embodiment of the present inventive concepts.

As shown in FIG. 1, the communication system 100 comprises a first user end 120, a second user end 130 and a server end 110. The number of the second user end 130 may be one or more. The first user end 120 may have a computer device. The computer device of the first user end 120 may comprise an input apparatus 121, a monitor 122, a memory 123, a processor (or a plurality of processors) 124 and a communication component 125. Further, the computer device of the second user end 130 may be similar to the computer device of the first user end 120, so the detailed description thereof is omitted. The server end 110 may have a server system. The server system of the server end 110 may comprise a memory 111, a processor (or a plurality of processors) 112 and a communication component 113. The server system of the server end 110 may be connected to the Internet 140. The server system of the server end 110 may communicate with other multimedia content sources 150.

The first and second user ends 120, 130 may execute software stored in a non-transitory computer-readable storage medium. For example the first and second user ends 120, 130 may be equipped with real-time communication application procedure. The server end 110 may be a real-time communication software server.

The first user end 120 (or the second user end 130) may be any device as long as the device can realize functions described in the example embodiments below. The first user end 120 (or the second user end 130) is, for example, a smart phone. An example of the first user end 120 (or the second user end 130) may include a mobile phone (e.g., a feature phone), a computer (e.g., a desktop, laptop, or tablet computer), a media computer platform (e.g., a cable, a satellite set-top box, or a digital video recorder), a handheld computing device (e.g., a personal digital assistant (PDA) or an e-mail client), a wearable terminal (e.g., a glasses type device or a clock type device), another type of computer, or a communication platform. However, in the present inventive concepts, the first user end 120 (or the second user end 130) is not limited thereto. Further, the first user end 120 (or the second user end 130) may be indicated as an information processing device.

The server end 110 includes a function of providing a service (e.g., a desired or predetermined service) to the first user end 120 and/or the second user end 130. The server end 110 may be any type of information processing device as long as the device can realize functions described in the example embodiments below. The server end 110 may be, for example, a server device. Another example of the server end 110 may include a computer (e.g., a desktop, laptop, or tablet computer), a media computer platform (e.g., a cable, a satellite set-top box, or a digital video recorder), a handheld computing device (e.g., a PDA or an e-mail client), or another type of computer, or a communication platform. However, in the present inventive concepts, the server end 110 is not limited thereto. Further, the server end 103 may be indicated as an information processing device.

For example, the input apparatus 121 of the computer device (e.g., the first user end 120) may provide an input interface for the first user inputting text message, inputting an operation instruction, or pressing a selection button. Further, the input apparatus 121 of the computer device (e.g., the first user end 120) may provide an input interface in a chat room for the first user to set user input conditions through the input interface. The monitor 122 of the computer device (e.g., the first user end 120) may display the text message currently inputted by the first user, and may display a dialog record of the first user end 120. The memory 123 of the computer device (e.g., the first user end 120) may store the dialog record to be a historical dialog record. The processor 124 of the computer device (e.g., the first user end 120) may control the input apparatus 121, the monitor 122, the memory 123 and the communication component 125 to perform the corresponding operations. For example, the processor 124 of the computer device (e.g., the first user end 120) may control the memory 123 to search the historical dialog record as stored, rearrange a sequence of images, generate a downloading page or a forwarding page of image, blur/mark images, store images or upload images. The communication component 125 of the computer device (e.g., the first user end 120) may transfer data, and command, and the like to the communication component 113 of the server end 110, and may receive the data and command from the communication component 113 of the server system.

The memory 111 of the server system may store the dialog record from the first user end 120 as the historical dialog record. According to some example embodiments, the historical dialog record may only be stored in the computer device of the first user end 120 or the server system of the server end 110, and may simultaneously be stored in both e computer device of the first user end 120 and the server system of the server end 110. The processor 112 of the server system (e.g., the server end 110) may control the memory 111 and the communication component 113 to perform the corresponding operations. For example, the processor 112 of the server system (e.g., the server end 110) may control the memory 111 to search the historical dialog record as stored, rearrange a sequence of images, generate a downloading page or a forwarding page of image, blur/mark images, store images or upload images. The communication component 113 of the server system (e.g., the server end 110) may connect the server system) to the communication component 125 of the computer device.

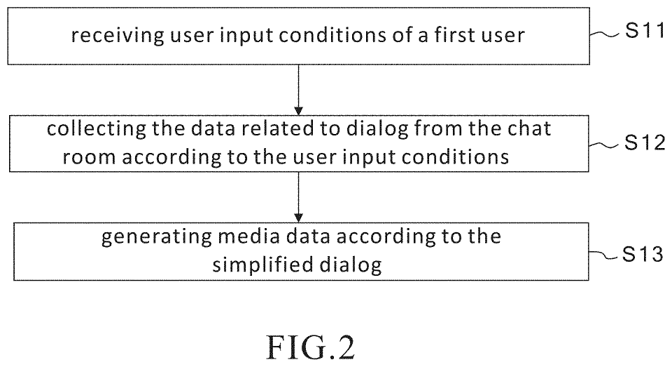

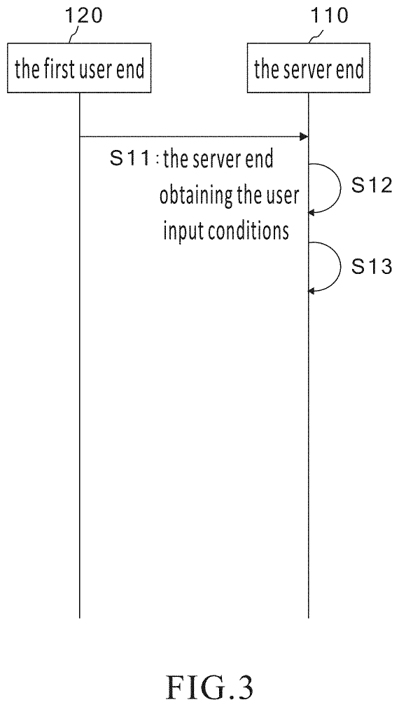

Referring to FIGS. 2 and 3, FIG. 2 is a flow chart of a method for collecting data related to dialog according to an example embodiment of the present inventive concepts, and FIG. 3 is a schematic diagram of a method for collecting data related to dialog of FIG. 2 realized in the communication system of FIG. 1.

Referring to FIG. 2, the method for collecting data related to dialogs may include the following three operations of S11-S13. The operation S11 is receiving user input conditions of a first user of a first user end 120, when members in a chat room include the first user and one or more second users associated with the first user. The operation S12 is collecting the data related to dialog from the chat room according to the user input conditions to generate a simplified dialog in accordance with the user input conditions. The operation S13 is generating media data according to the simplified dialog.

The one or more second users may be personal friend(s) of the first user or friend(s) in a group where the first user attends, and may operate the one or more second user ends 130. The first user and any one of the second users may engage in a one-on-one chat room. In some example embodiments, the first user and a plurality of the second users may engage in a group chat room.

The first user may display the one-on-one chat room and/or the group chat room by the computer device (e.g., the monitor 122) of the first user end 120. In the chat room, the first user may input the user input conditions by the input apparatus 121 of the computer device of the first user end 120. For example, the computer device of the first user end 120 may provide the input interface associated with the chat room to the first user for inputting the user input conditions from the computer device of the first user end 120. The user input conditions may include at least one of specific user identifications in the chat room, at least one of specific time intervals and/or the numbers of message prior to/after the user message in the chat room.

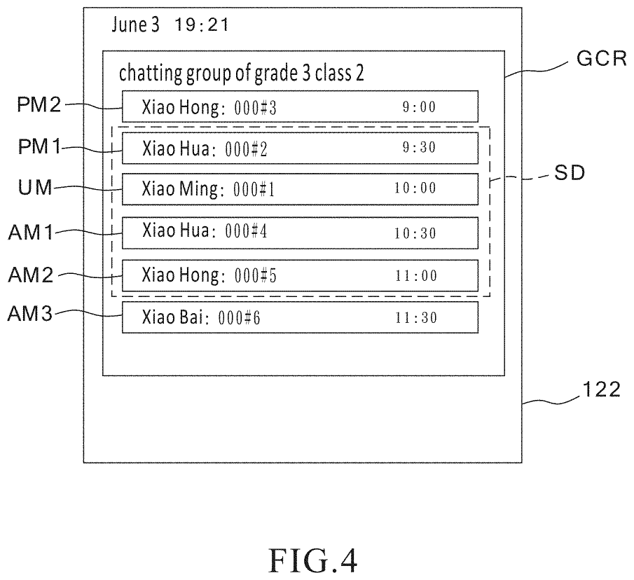

FIG. 4 is a schematic diagram illustrating a method of collecting the data related to dialog from a group chat room GCR and generating a simplified dialog SD, according to the user input conditions. For example, in the group chat room GCR, the first user may input the user input conditions of “from 9:00 am to 12:00 am of June 1, (1, 2)”, wherein the user identification of the first user is “Xiao Ming”, the specific time interval is from 9:00 am to 12:00 am of June 1 is, and (1, 2) represents that the simplified dialog should acquire the user message (UM) of the specific user identification, a message (PM1) prior to the user message (UM), and two messages (AM1, AM2) after the user message.

FIG. 4 illustrates a scenario that the user visits the group chat room GCR at 19:21 of June 3, and wants to perform the collection of the data related to dialog. The user message, UM, shows “Xiao Ming:OOO#1 10:00”, wherein Xiao Ming is a sender of the message, “OOO#1” indicates the message content of Xiao Ming, “10:00” indicates that the message time is 10:00 am of June 1. Message PM1 is the first message prior to the user message UM according to the time sequence, and shows “Xiao Hua:OOO#2 9:30”, message PM2 is the second message prior to the user message UM according to the time sequence, and shows “Xiao Hong:OOO#3 9:00”, and so on upwards. Message AM1 is the first message after the user message UM according to the time sequence, and shows “Xiao Hua:OOO190 4 10:30”, message AM2 is the second message after the user message UM according to the time sequence, and shows “Xiao Hong:OOO#5 11:00”, and message AM3 is the third message after the user message UM according to the time sequence, and shows “Xiao Bai:OOO#6 11:30”. Finally, the simplified message SD including the user message UM and the messages PM1, AM1 and AM2 is generated according to inputting the user input conditions of “from 9:00 am to 12:00 am of June 1, (1, 2)”.

Further, for example, the first user may input the user input conditions of “Xiao Hong, from 9:00 am to 12:00 am of June 1”, wherein “Xiao Hong” is the specific user identification, so the simplified message including the messages PM2 and AM2 (e.g., all the messages from 9:00 am to 12:00 am of June 1 of Xiao Hong) is generated. Next, the generated simplified message may be changed into media data, and the media data may be one of the text data, audio and video data, image data and/or audio data. For example, the media data may be image data that is obtained by rearranging a plurality of snipped images.

Referring to FIG. 3, the operation S11 may be carried out in the first user end 120, and both the operation S12 and operation S13 may be carried out in the server end 110. However, the inventive concepts are not limited to the disclosed example embodiment. For example, in some example embodiments, all of the operation S11, operation S12 and operation S13 may be carried out in the first user end 120.

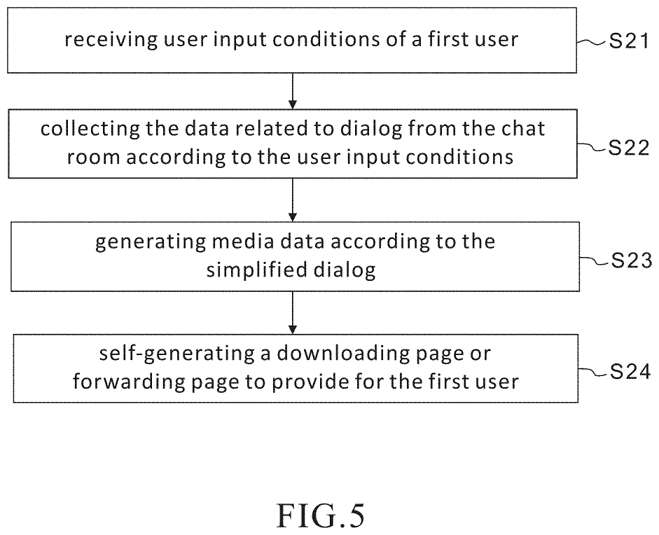

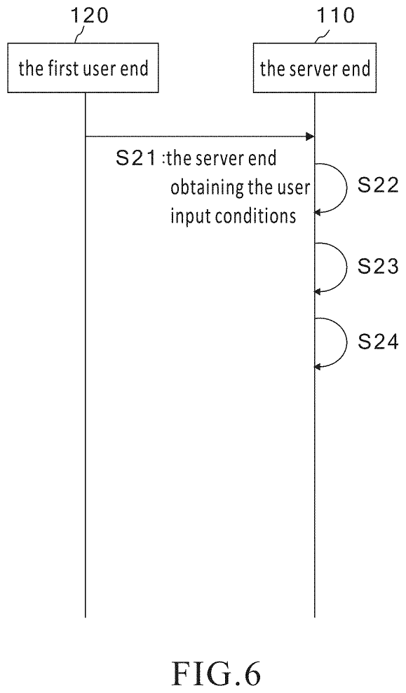

Referring to FIGS. 5 and 6, FIG. 5 is a flow chart of a method for collecting data related to dialog according to an example embodiment of the present inventive concepts, and FIG. 6 is a schematic diagram of a method for collecting data related to dialog of FIG. 5 realized in the communication system of FIG. 1.

The operations S21-S23 of FIG. 5 are substantially similar to or the same as the operation S11-S13 of FIG. 2, and thus the detailed description thereof is omitted.

The method may include the following four operations of S21-S24. The operation S21 is receiving user input conditions of a first user, when members in a chat room include the first user and one or more second users associated with the first user. The operation S22 is collecting data related to dialog from the chat room according to the user input conditions to generate a simplified dialog in accordance with the user input conditions. The operation S23 is generating media data according to the simplified dialog. The operation S24 is generating a downloading page, which includes a downloading link associated with the media data, or a forwarding page, which includes a forwarding link associated with the media data, to allow the first user to download or forward the media data. Accordingly, the first user may download or forward the media data by using the computer device of the first user end 120.

In some example embodiments, the media data may be compressed and/or encrypted, and the compressed and/or encrypted media data may be downloaded by the downloading link or the forwarding link.

Referring to FIG. 6, the operation S21 is carried out in the first user end 120, and all the operation S22, operation 23 and operation S24 are carried out in the server end 110. However, the inventive concepts are not limited to such an example embodiment. For example, in some example embodiment, all the operation S21, operation S22, operation S23 and operation S24 may be carried out in the first user end 120.

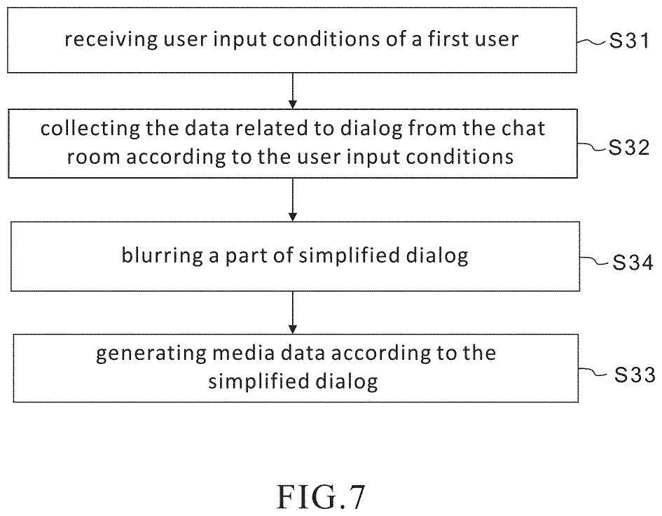

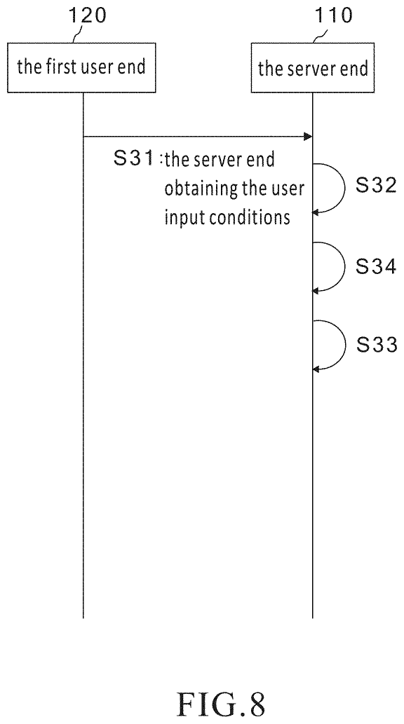

Referring to FIGS. 7 and 8, FIG. 7 is a flow chart of a method for collecting data related to dialog according to an example embodiment of the present inventive concepts, and FIG. 8 is a schematic diagram of a method for collecting data related to dialog of FIG. 7 realized in the communication system of FIG. 1.

The operations S31-S33 of FIG. 7 are substantially similar to or the same as the operations S11-S13 of FIG. 2, and thus the description thereof is omitted.

The method may include the following four operations of S31-S34. The operation S31 is receiving user input conditions of a first user, when members in a chat room include the first user and one or more second users associated with the first user. The operation S32 is collecting data related to dialog from the chat room according to the user input conditions to generate a simplified dialog in accordance with the user input conditions. The operation S33 is generating media data according to the simplified dialog. The operation S34 is blurring a part of simplified dialog and may be performed between the operation S32 and the operation S33. In the operation S33, a part of the simplified dialog is blurred before generating the media data associated with the simplified dialog. Therefore, in the embodiment, the operation S34 is carried out before the operation S33.

In the step S34, the server system may blur a part of simplified dialog. For example, the blurred part of the simplified dialog may include at least one of specific user identifications, at least one of specific user messages and/or at least one of specific user image mark. Accordingly, when the first user downloads or forwards the media data by the terminal device (e.g., the monitor 122) of the first user end 120, classified data may be protected from leaking, thereby ensuring the privacy for the simplified dialog in the media data.

The blurred part of the simplified dialog may be pre-determined. For example, the server system may set the user identifications and the user image marks that need to be blurred by default. Alternatively, the blurred part of the simplified dialog may be decided based on the blurred conditions that are received from the first user.

Referring to FIG. 8, the step S31 is carried out in the first user end 120, and all of the operation S32, operation 33 and operation S34 are carried out in the server end 110. However, the inventive concepts are not limited to such an example embodiment. For example, in some example embodiments, all of the operation S31, operation S32, operation S33 and operation S34 may be carried out in the first user end 120.

In the example embodiment of FIG. 8, the operation S34 is carried out before the operation S33 so that the media data can be generated according to the simplified dialog that has been blurred. However, the inventive concepts are not limited to such an embodiment. The operation S34 may be carried out after the operation S33. The media data can be generated according to the simplified dialog that has not been blurred, and then a part of the media data may be blurred after the media is generated.

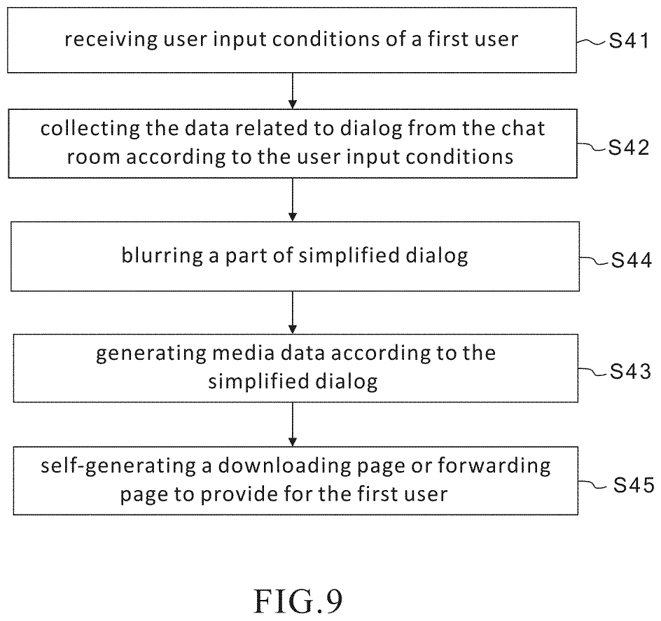

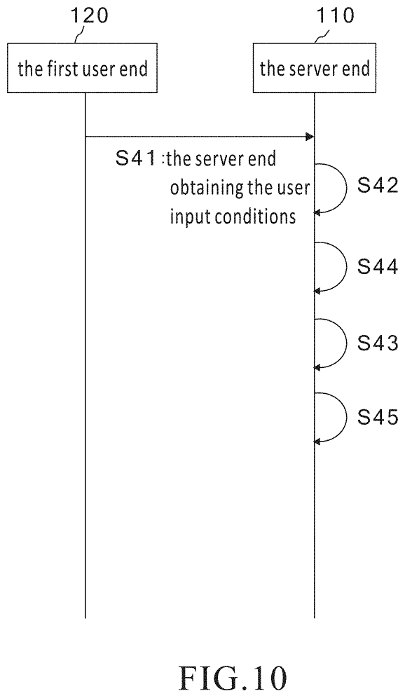

Referring to FIGS. 9 and 10, FIG. 9 is a flow chart of a method for collecting data related to dialog according to an example embodiment of the present inventive concepts, and FIG. 10 is a schematic diagram of a method for collecting data related to dialog of FIG. 9 realized in the communication system of FIG. 1.

The operations S41-S44 of FIG. 9 are substantially similar to or the same as the operations S31-S34 of FIG. 7, and thus the detailed description thereof is omitted.

The method comprises the following five operations of S41-S45. The operation S41 is receiving user input conditions of a first user, when members in a chat room include the first user and a second user associated with the first user. The operation S42 is collecting data related to dialog from the chat room according to the user input conditions to generate a simplified dialog in accordance with the user input conditions. The operation S43 is generating media data according to the simplified dialog. The operation S44 is blurring a part of simplified dialog. The media data of the operation S43 is generated according to the simplified dialog which has been blurred in the operation S44. Therefore, in the example embodiment, the operation S44 is carried out before the operation S43. The operation S45 is generating a downloading page, which includes a downloading link associated with the media data, or a forwarding page, which includes a forwarding link associated with the media data to provide for the first user.

Further, the inventive concepts disclose a non-transitory computer-readable storage medium that may collect the data related to dialog. The non-transitory computer-readable storage medium comprises procedure codes written by a programmer to realize one of the embodiments of the above-mentioned methods or other alterations of embodiments of the methods. Because there is a detailed description for embodiments of the methods in the foregoing paragraphs, the description of the non-transitory computer-readable storage medium is omitted herein.

Further, the inventive concepts discloses a computer device, which is configured to collect the data related to dialog. The computer device may be used to realize one of the methods of the disclosed example embodiments or one of other methods of modified example embodiments. For example, the computer device may include a searching module (not shown), a media data-generating module (not shown), a downloading page or forwarding page generating module (not shown) and a blurring module (not shown). The searching module may carry out the operation S41 and the operation S42 of FIG. 9. The media data generating module may carry out the operation S43 of FIG. 9. The downloading page or forwarding page generating module may carry out the operation S44 of FIG. 9. The blurring module may carry out the operation S45 of FIG. 9. Operations of the above functional modules of the computer device has been described in detail in the foregoing paragraphs, Thus, the further description of the computer device is omitted herein.

Further, the inventive concepts disclose a server system which is configured to collect the data related to dialog. The server system may be used to realize one of the methods of the disclosed example embodiments or one of other methods of modified example embodiments. For example, the server system may include a searching module (not shown), a media data-generating module (not shown), a downloading page or forwarding page generating module (not shown) and a blurring module (not shown). The searching module may carry out the operation S41 and the operation S42 of FIG. 9. The media data generating module may carry out the operation S43 of FIG. 9. The downloading page or forwarding page generating module may carry out the operation S44 of FIG. 9. The blurring module may carry out the operation S45 of FIG. 9. Operations of the above functional modules of the server system has been described in detail in the foregoing paragraphs. Thus, the further description of the server system is omitted herein.

Example embodiments of inventive concepts can be embodied as hardware or combinations of hardware and software. Example embodiments of inventive concepts can also be embodied as computer-readable codes on a non-transitory computer-readable medium. The non-transitory computer-readable recording medium is any data storage device that can store data as a program, which can be thereafter read by a computer system. Examples of the non-transitory computer-readable recording medium include read-only memory (ROM), random-access memory (RAM), CD-ROMs, magnetic tapes, floppy disks, and optical data storage devices. The non-transitory computer-readable recording medium can also be distributed over network coupled computer systems so that the non-transitory computer-readable code is stored and executed in a distributed fashion. In addition, functional programs, codes, and code segments according to example embodiments of inventive concepts can be construed by programmers having ordinary skill in the art to which example embodiments of inventive concepts pertain.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher-level program code that is executed using an interpreter.

Various processors described in this disclosure may include processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The inventive concepts provide products, devices and/or systems for collecting the data related to dialog from the chat room according to the user input conditions. Therefore, the methods, products, devices and/or systems of the inventive concepts may provide users with a more convenient and time-saving user experience.

While the present disclosure has been described by means of some example embodiments, numerous modifications and variations could be made thereto by those skilled in the art without departing from the scope and spirit of the present disclosure as set forth in the claims.

What is claimed is:

1. A method comprising:
receiving one or more user input conditions of a first user for a chat room including the first user and one or more second users associated with the first user;
collecting data related to dialog from the chat room according to the user input conditions to generate a simplified dialog; and
generating media data according to the simplified dialog.

2. The method according to claim 1, wherein
the media data is one of text data, audio and video data, image data, or audio data, and
the user input conditions include at least one of specific user identifications in the chat room, at least one of specific time intervals, at least one of a number of messages prior or after the first user message in the chat room, or combinations thereof.

3. The method according to claim 1, further comprising:
generating a downloading page including a downloading link associated with the media data or a forwarding page including a forwarding link associated with the media data to allow the first user to download or forward the media data.

4. The method according to claim 1, further comprising:
blurring a part of the simplified dialog before the generating,
wherein the generating generates the media data according to the simplified dialog, which has been blurred in the blurring.

5. The method according to claim 4, wherein the blurred part of the simplified dialog includes at least one of specific user identifications, at least one of specific user messages, at least one of specific user image marks, or a combination thereof.

6. The method according to claim 4, further comprising:
receiving specific conditions for the blurring from the first user; and
deciding the part of the simplified dialog to be blurred based on the specific conditions for the blurring.

7. The method according to claim 1, further comprising:
providing a user device of the first user with an input interface associated with the chat room that is configured to receive the user input conditions.

8. The method according to claim 3, wherein the generating includes,
at least one of compressing or encrypting the media data, and
generating the downloading page or the forwarding page to allow the first user to download or forward the at least one of compressed or encrypted media data based on the downloading link or the forwarding link.

9. A non-transitory computer-readable storage medium storing instructions that, when executed by a computer, cause the computer to implement a method of collecting and providing dialog-related data, the method comprising:
receiving one or more user input conditions of a first user for a chat room including the first user and one or more second users associated with the first user;
collecting data related to dialog according to the user input conditions to generate a simplified dialog; and
generating media data according to the simplified dialog.

10. The non-transitory computer-readable storage medium according to claim 9, wherein the method further comprising:
generating a downloading page including a downloading link associated with the media data or a forwarding page including a forwarding link associated with the media data to allow the first user to download or forward the media data.

11. The non-transitory computer-readable storage medium according to claim 9, wherein the method further comprising:
blurring a part of the simplified dialog.

12. A computer device comprising:
a memory configured to store computer device-readable instructions; and
one or more processors configured to execute the computer device-readable instructions such that one or more processors are configured to,
receive one or more user input conditions of a first user for a chat room,
collect data related to dialog according to the user input conditions to generate a simplified dialog, and
generate media data according to the simplified dialog.

13. The computer device according to claim 12, wherein the one or more processors are further configured to:
generate a downloading page including a downloading link associated with the media data or a forwarding page including a forwarding link associated with the media data to allow the first user to download or forward the media data.

14. The computer device according to claim 12, wherein the one or more processors are further configured to:
blur a part of the simplified dialog.
